(19) United States
(12) Patent Application Publication
(10) Pub. No.: US 2011/0101679 A1
(43) Pub. Date: May 5, 2011

(54) METHODS, SYSTEMS AND APPARATUSES FOR SEGMENTAL DUCT COUPLERS

(76) Inventors: John R. Crigler, Woodbine, MD (US); James G. Young, Midlothian, TX (US); Michael R. Moussa, Euless, TX (US)

(21) Appl. No.: 12/903,696

(22) Filed: Oct. 13, 2010

Related U.S. Application Data
(60) Provisional application No. 61/278,839, filed on Oct. 13, 2009.

(51) Int. Cl. F16L 21/00; F16L 19/04

(52) U.S. Cl. 285/235; 285/382

(57) ABSTRACT

The subject matter disclosed herein relates to methods, systems and apparatuses for segmental duct couplers for use during and after formation of concrete segments. Segmental duct coupling systems can include a number of components for coupling ducts both during and after formation of the concrete segments. In one aspect, the coupling system can include a locking member and forming member disposed between coupling ends of segmental ducts. In another aspect, a coupling system can include a deformable member disposed between coupling ends of ducts cast within pre-cast and match-cast concrete segments.

### CROSS REFERENCE TO RELATED APPLICATIONS

This application claims the benefit of U.S. Provisional Patent Application Ser. Nos. 61/278,839 filed Oct. 13, 2009 and 61/342,463 filed Apr. 14, 2010, the disclosures of which are incorporated herein by reference in their entireties.

### TECHNICAL FIELD

The subject matter disclosed herein relates generally to methods, systems and apparatuses for segmental duct couplers. More specifically, the subject matter disclosed herein relates to methods, systems and apparatuses for segmental duct couplers for use during and after formation of concrete segments.

### BACKGROUND

Structural systems and methods commonly utilize concrete segments which can assemble together to form structural elements such as bridges and roadways. In constructing concrete segments, the concrete is typically poured around flexible internal members, for example, segmental ducts which are capable of coupling end-to-end to form water-tight seals. Once fully constructed, the ends of the segmental ducts can be located on outer faces of the concrete segments. The segmental ducts within the concrete segments can thus couple together to form a network of ducts in which post-tensioning elements, such as metal rods, may be inserted to compress the segments together. The ends of the ducts can couple several concrete segments adjacent to each other and form a leak proof seal around the post-tensioning elements. The ducts can facilitate the protection of the post-tensioning elements from corrosive elements including salt and other de-icing chemicals which may accumulate on bridges and roadways.

Many approaches have tried to address problems of efficiently and inexpensively sealing the joints between adjacent sections of duct contained within concrete segment applications. Problems can arise, for example, when a longitudinal axis of the ducts is offset from normal within a concrete segment. Consequently, there remains a need for improved methods, systems and apparatuses for segmental duct couplers that overcome or alleviate shortcomings of prior art couplers.

### SUMMARY

In accordance with this disclosure, novel methods, systems and apparatuses for segmental duct couplers are provided. It is, therefore, an object of the present disclosure to provide methods, systems, and apparatuses for segmental duct couplers with improved efficiency, decreased cost, and the ability to couple ducts which may be offset from normal within concrete segments.

These and other objects of the present disclosure as can become apparent from the disclosure herein are achieved, at least in whole or in part, by the subject matter described herein.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures in which:

FIG. 1 illustrates a side view of a duct coupling system in accordance with the subject matter disclosed herein;

FIG. 2A is a sectional view and FIG. 2B is a side view illustrating coupling ends of a duct coupling system in accordance with the subject matter disclosed herein;

FIGS. 3A and 3B illustrate a duct hub of a duct coupling system in accordance with the subject matter disclosed herein;

FIGS. 4A to 4H illustrate locking rings of a duct coupling system in accordance with the subject matter disclosed herein;

FIGS. 5A and 5B illustrate a deformable member of a duct coupling system in accordance with the subject matter disclosed herein;

FIGS. 5C and 5D illustrate a forming member of a duct coupling system in accordance with the subject matter disclosed herein;

FIG. 6 illustrates a bulkhead used in forming concrete segments in accordance with the subject matter disclosed herein;

FIG. 7 illustrates an alternative of the bulkhead used in forming concrete segments in accordance with the subject matter disclosed herein;

FIGS. 8A and 8B illustrate a forming tool used in forming concrete segments in accordance with the subject matter disclosed herein;

FIG. 9 illustrates a duct coupling system for forming concrete segments in accordance with the subject matter disclosed herein;

FIG. 10 illustrates a duct coupling system for coupling concrete segments in accordance with the subject matter disclosed herein; and

FIG. 11 illustrates a cross-sectional view of a duct coupling system within concrete segments in accordance with the subject matter disclosed herein.

### DETAILED DESCRIPTION

Reference will now be made in detail to possible embodiments of the present subject matter, one or more examples of which are shown in the figures. Each example is provided to explain the subject matter and not as a limitation. In fact, features illustrated or described as part of one embodiment can be used in another embodiment to yield still a further embodiment. It is intended that the subject matter disclosed and envisioned herein covers such modifications and variations.

As illustrated in the various figures, some sizes of structures or portions are exaggerated relative to other structures or portions for illustrative purposes and, thus, are provided to illustrate the general structures of the present subject matter. Furthermore, various aspects of the present subject matter are described with reference to a structure or a portion being formed on other structures, portions, or both. As will be appreciated by those of skill in the art, references to a structure being formed “on” or “above” another structure or portion contemplates that additional structure, portion, or both may intervene. References to a structure or a portion being formed “on” another structure or portion without an intervening structure or portion are described herein as being formed “directly on” the structure or portion. Similarly, it will be understood that when an element is referred to as being “connected”, “attached”, or “coupled” to another element, it can be directly connected, attached, or coupled to the other element, or intervening elements may be present. In contrast, when an element is referred to as being “directly connected”, “directly attached”, or “directly coupled” to another element, no intervening elements are present.

Furthermore, relative terms such as “on”, “above”, “upper”, “top”, “lower”, or “bottom” are used herein to describe one structure's or portion's relationship to another structure or portion as illustrated in the figures. It will be understood that relative terms such as “on”, “above”, “upper”, “top”, “lower” or “bottom” are intended to encompass different orientations of the device in addition to the orientation depicted in the figures. For example, if the device in the figures is turned over, structure or portion described as “above” other structures or portions would now be oriented “below” the other structures or portions. Likewise, if devices in the figures are rotated along an axis, structure or portion described as “above”, other structures or portions would now be oriented “next to” or “left of” the other structures or portions. Like numbers refer to like elements throughout.

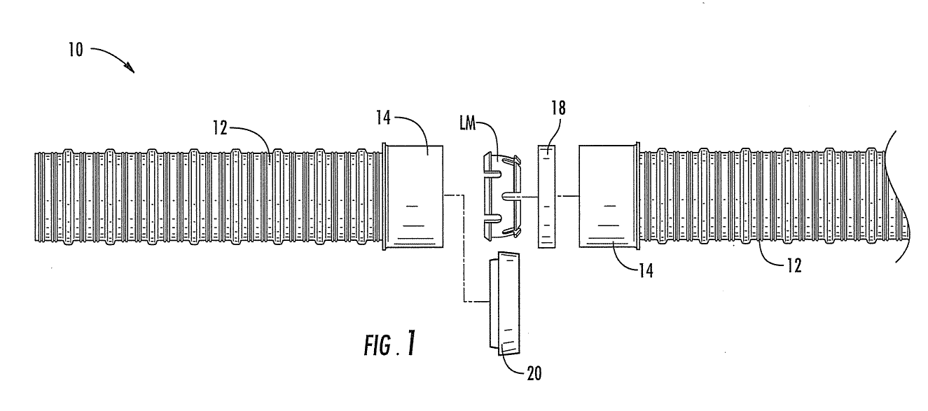

Embodiments of the present subject matter will be described with reference to FIGS. 1-11. FIG. 1 illustrates components comprising a duct coupling system, generally designated 10. One embodiment of duct coupling system 10 can be used for coupling concrete segments during formation, or casting of the segments. Another embodiment of duct coupling system 10 can be used to assemble concrete segments on a work site to form structural elements, such as bridges and roadways. Duct coupling system 10 can comprise one or more segmental ducts having one or more coupling ends. The segmental ducts with coupling ends can be cast, for example, within concrete segments.

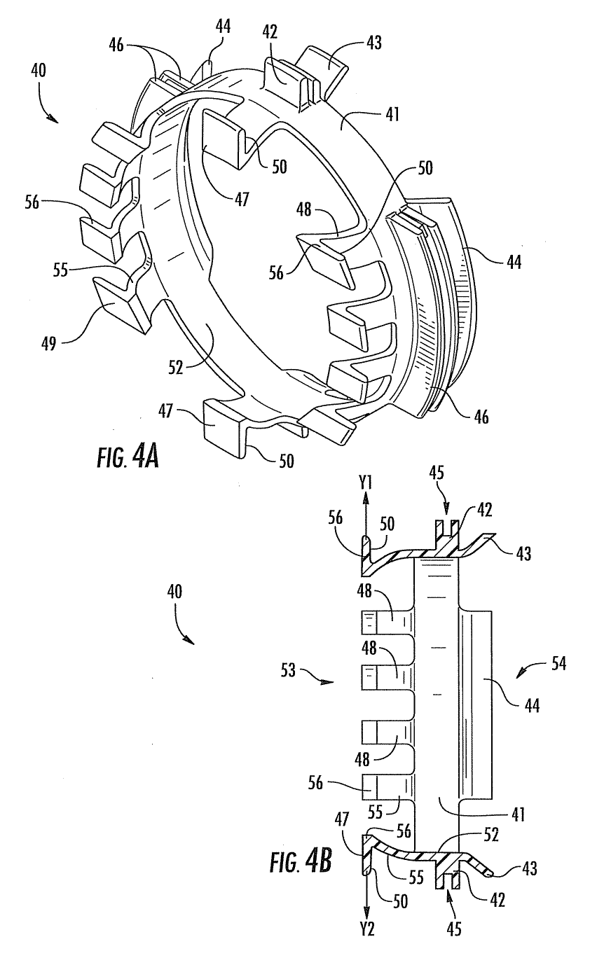

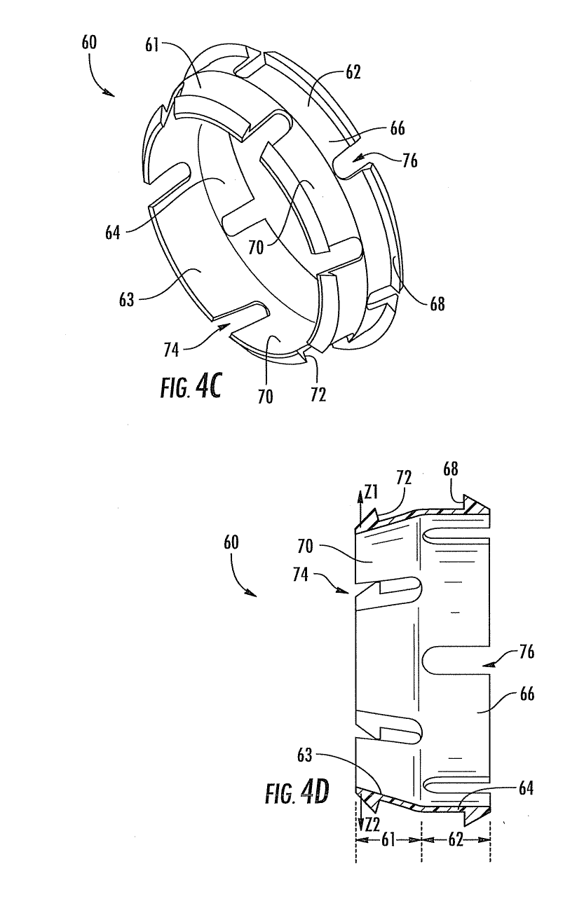

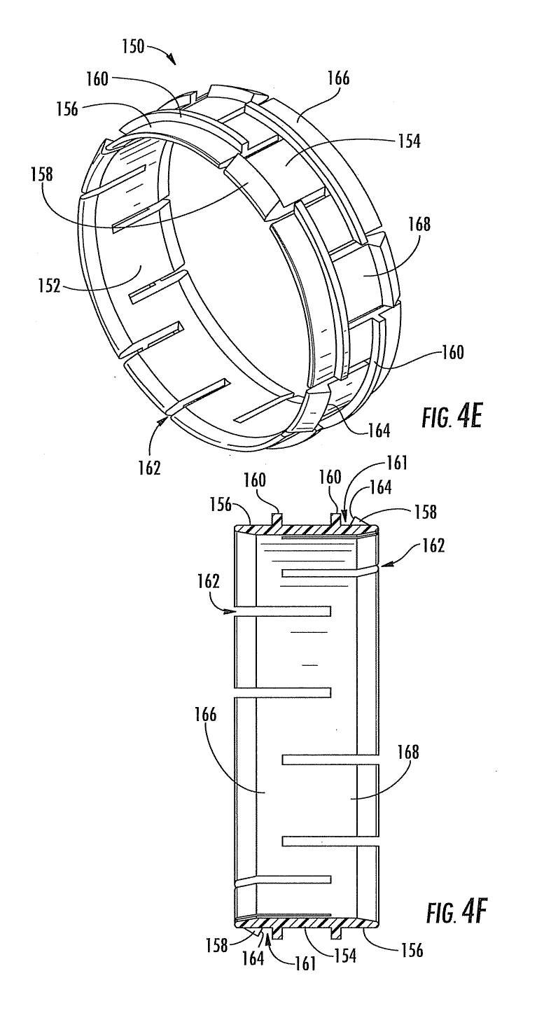

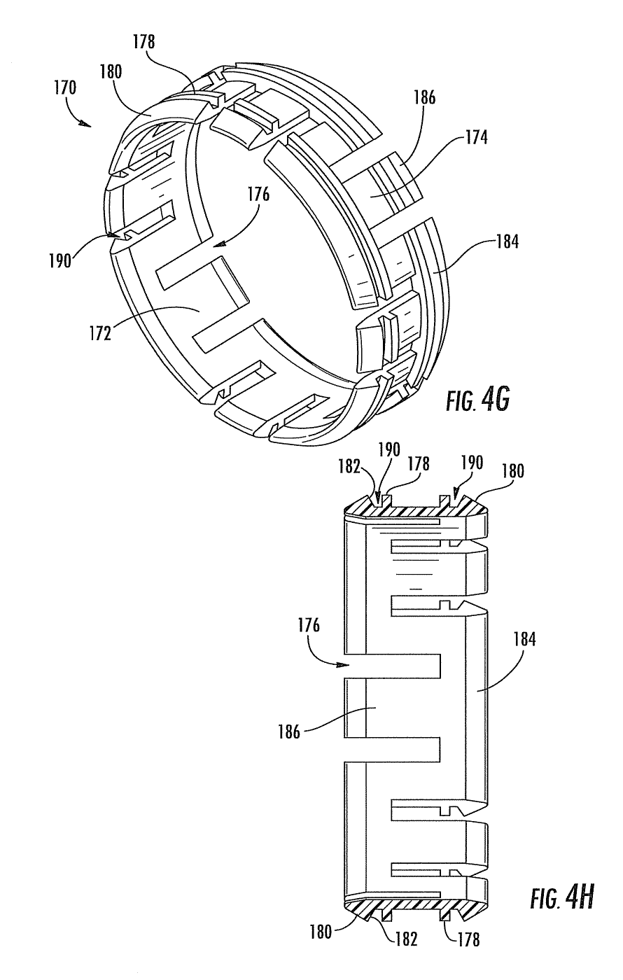

A first embodiment of duct coupling system 10 comprises at least one segmental duct 12 having a duct hub 14 attached at a first coupling end of the duct 12. Duct 12 can comprise any material known in the art, for example, a flexible polypropylene material. Duct coupling system 10 can further comprise a locking member, generally designated LM, and a forming member 18 which can be used during formation of the concrete segments. Locking member LM can comprise various embodiments, such as 40, 60, 150, and 170 illustrated in FIGS. 4A-4H. Wet concrete can be poured about duct 12 having duct hub, locking member LM, and forming member 18. The locking member LM and forming member 18 can be removed once the concrete segments have been adequately formed and dried.

In a second embodiment of duct coupling system 10, system 10 can comprise duct 12 with duct hub 14 attached at a coupling end, and a deformable member 20. Deformable member 20 can be used on a work site to provide a quick and easy method of coupling concrete segments together. Deformable member 20 is used in place of locking member LM and forming member 18 to assist in coupling together the ends of ducts 12 within concrete segments. Deformable member 20 can be positioned between duct hubs 14 of opposing concrete segments, and the segments can be tensioned together. Deformable member 20 can couple the segments together thereby forming a network of ducts through which post-tensioning elements may be inserted.

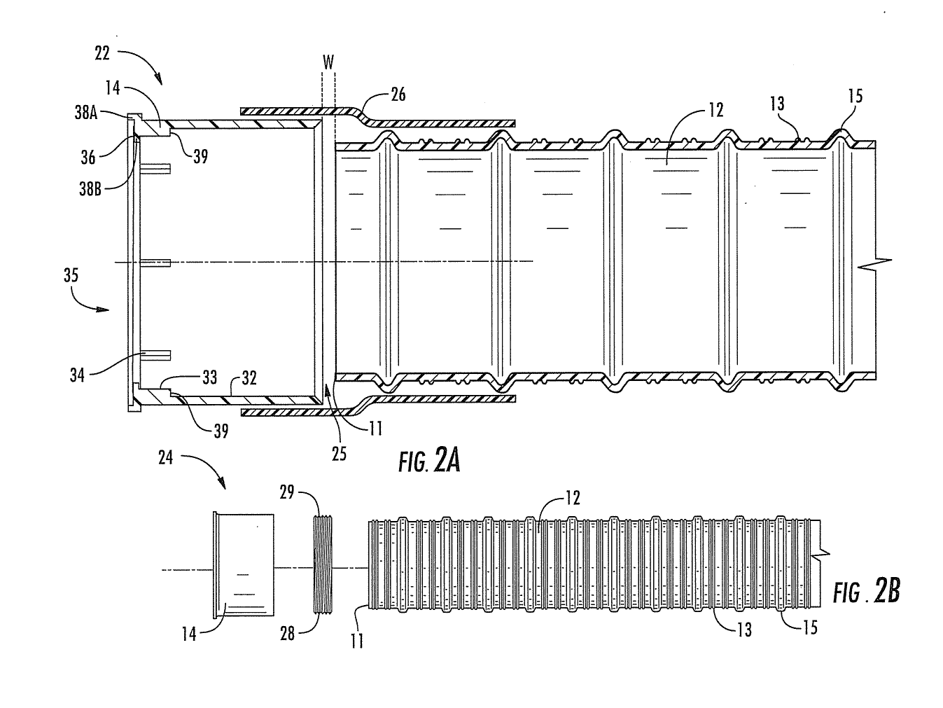

FIGS. 2A and 2B illustrate embodiments of coupling ends, generally designated 22 and 24, respectively. Coupling ends 22 and 24 can couple one or more segmental ducts 12 together. Segmental ducts 12 can be cast within concrete segments such that at least a portion of the coupling ends 22 or 24 are exposed along a face of the concrete segments. One or more concrete segments can couple together when the respective coupling ends are joined 22 or 24 using components including forming member 18, locking member LM, or deformable member 20, either alone or in combination as described herein. Coupling ends 22 and 24 can be located at opposing ends of a duct 12 segment. Ducts 12 having coupling ends 22 and/or 24 can be pre-cast into concrete segments, and coupling ends 22 and/or 24 can then link together such that the concrete segments form structural concrete elements, such as bridges. As illustrated by FIG. 2A, coupling end 22 comprises a duct 12 segment having a first end 11 adjacent duct hub 14. First end 11 and duct hub 14 can link, or connect, together using a flexible external member 26. External member 26 can comprise any flexible material known in the art capable of holding duct 12 to duct hub 14, for example, a heat shrink material or flexible wrap. External member 26 can be disposed about each of the duct hub 14 and the duct 12 segment, such that a gap 25 forms and exists. Coupling end 22 can further comprise gap 25 having a width W between the first end 11 and duct hub 14. Width W can comprise a range greater than or equal to zero (0) centimeters such that there is no overlap between duct hub 14 and duct 12. This procedure can be repeated for an opposing end of duct 12 segment, thereby forming a duct segment comprising two coupling ends 22. Once the coupling ends are assembled onto the ends of duct 12 segment, the duct 12 segment is ready to be cast into a concrete segment.

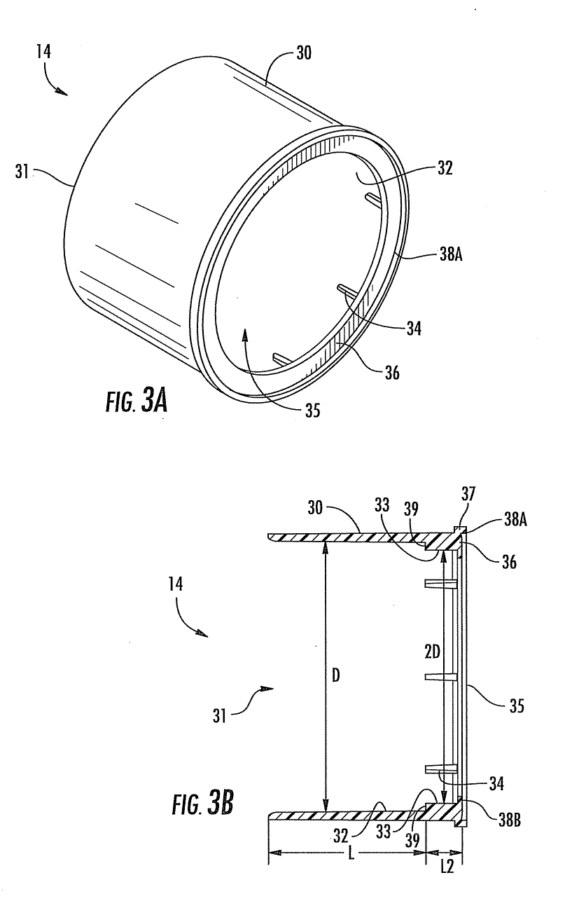

FIG. 2B illustrates an alternative embodiment of coupling end 24. Coupling end 24 can comprise duct 12 segment having a first end 11 attached to duct hub 14 by using a flexible intervening duct ring 28 disposed therebetween. Duct 12 can comprise one or more small ribs 13 and one or more large ribs 15. Duct ring 28 can be inserted over first end 11 and attach duct hub 14 to first end 11. For example, duct ring 28 can be installed over first end 11 by pushing duct ring 28 over the small ribs 13 until it abuts against large rib 15. Duct ring 28 can comprise any flexible and/or elastomeric material known in the art, for example, a thermoplastic vulcanizate (TPV). TPV is a soft, black UV resistant material in the thermoplastic elastomer family useful in sealing applications. Duct hub 14 can be lubricated using, for example, a silicon or oil-based lubricant and pushed over the duct ring 28. This process can be repeated at an opposing end of duct 12, thereby forming a duct segment comprising two coupling ends 24. Duct hub 14 and duct 12 can be held together because of a frictionally engaging fit between an internal wall of duct hub (FIGS. 3A and 3B) and a ribbed outer surface 29 of duct ring 28. Once coupling ends 24 are assembled onto the ends of duct 12 segment, the duct segment is ready to be cast into a concrete segment.

FIGS. 3A and 3B illustrate perspective and cross-sectional views, respectively, of duct hub 14. Duct hub 14 can comprise any flexible material known in the art, for example a polypropylene material. As illustrated in FIGS. 2A and 2B, gap 25 can exist between duct 12 and duct hub 14, or in the alternative, duct hub 14 can fit about duct 12 having duct ring 28 disposed therebetween. FIG. 3A illustrates duct hub 14 comprising a substantially cylindrical hollow body having an outer wall 30 and first and second ends 31 and 35 respectively. First end 31 comprises a first opening having a first diameter D. Second end 35 comprises a second opening having a second diameter 2D. First end comprises an inner wall 32 having first diameter D. Inner wall 32 extends a first length L of duct hub 14 until it reaches a portion having second inner wall 33. Second end 35 comprises second inner wall 33 of second diameter 2D, wherein 2D can be smaller than D. Second diameter 2D can extend along second inner wall 33 for a second length L2 of duct hub 14. Second length L2 terminates at ledge 37 which defines a shelf 36 perpendicular to inner wall 33. In an embodiment wherein duct hub 14 uses duct ring 28 to engage with duct 12, an outer diameter of duct ring 28 is at least equal to D to allow frictional engagement between duct ring 28 and duct hub 14. Stated differently, the overall diameter of duct 12 and duct ring 28 can be at least equal to D to allow for frictional engagement of duct ring 28 to duct hub 14, thereby allowing duct hub 14 to assemble about duct 12.

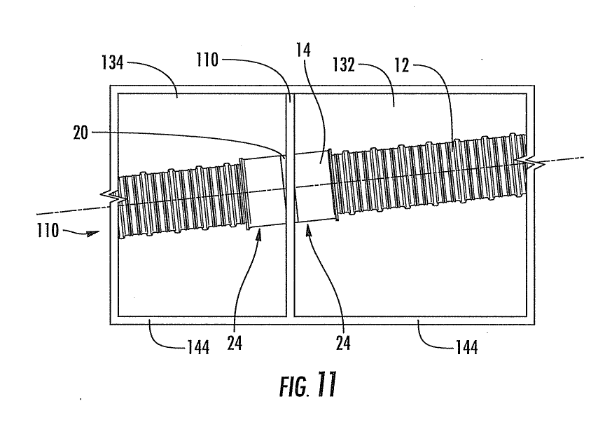

Outer wall 30 of duct hub 14 can be generally cylindrical in shape and formed about hollow openings defined by first and second inner walls 32 and 33 of first and second ends 31 and 35, respectively. Ledge 37 can form at second end 35 and comprises shelf 36 upon which components, for example, forming member 18 or deformable member 20 can rest, or engage. Ledge can comprise a first protrusion 38A and a second protrusion 38B, the first and second protrusions being perpendicular to each other and disposed at opposite ends of shelf 36. First protrusion 38A can substantially surrounded shelf 36 thereby forming a raised outer rim. First protrusion 38A can further engage, and retain components of duct coupling system 10, for example, forming member 18 and/or deformable member 20 as described in FIGS. 9 and 10 further below. Shelf 36 can oppose, and substantially parallel to an opposing surface 39. Opposing surface 39 can be disposed between first and second inner walls 32 and 33, respectively. A distance between shelf 36 and opposing surface 39 is second length L2.

Still referring to FIGS. 3A and 3B, shelf 36 can be supported by one or more support members 34. Support members 34 can comprise bodies molded or otherwise formed, in duct hub 14 and comprise a longitudinal length along second length L2. Support members 34 can be spaced at equidistant intervals about the periphery of second end 35. One or more support members 34 can be disposed under shelf 36 for bolstering the amount of support shelf 36 can provide to another component, for example, deformable member 20 or forming member 18, when the duct hub 14 is under compression. When duct 12 with coupling end (24 or 22) becomes cast within a concrete segment, the respective lengths L2 and L can be disposed parallel to a longitudinal axis of the duct. Second end of the duct hub can be exposed along a face of the concrete segment, such that shelf 36 of the duct hub is disposed along a face of the concrete segment.

FIGS. 4A to 4H illustrate various embodiments of a locking member, LM. Locking member LM can comprise locking rings 40, 60, 150, and 170. FIG. 4A illustrates perspective and cross-sectional views of locking ring 40. Locking ring comprises a substantially annular ring having an outer wall 41 and an inner wall 52. Locking ring 40 can comprise a first end 53 and a second end 54. First end 53 can comprise one or more projection tabs 48 which project outwardly from outer wall 41. Projection tabs 48 can be spaced at varying intervals about the locking ring 40. Projection tabs can comprise a curved projecting portion 55 which curves slightly inwardly and terminates at a gripping portion 56. Gripping portion 56 of a projection tab 48 can comprise a first flat surface 47 parallel and opposing a second flat surface 50. First surface 47 of the one or more projection tabs 48 can be located on a same plane which is parallel to a plane formed by the inner wall 52 of locking ring 40. Locking ring 40 can comprise any tough but flexible material known in the art, for example, a nylon super tough material. Each gripping portion 56 of projection tabs 48 can flex in a direction radially outwards from locking ring 40 as indicated by Y1 and Y2. When gripping portions 56 flex outwardly, they can grip surfaces of various components, for example, opposing surface 39 of duct hub 14.

Locking ring 40 can further comprise first and second clip members 42 and 46 located and spaced along outer wall 41 of locking ring 40. First and second clip members 42 and 46 can be perpendicular to projecting tabs 48. First clip members 42 can have a shorter width along the outer wall 41 than second clip members 46 along the outer wall 41. First and second clip members 42 and 46, respectively, can include a groove 45 allowing the members to grasp various components during the concrete segment forming process.

Second end 54 of locking ring 40 can comprise one or more first and second guide members 43 and 44, respectively. First and second guide members 43 and 44 can project radially outward from second side 54 of locking ring 40 at a given angle, and can be spaced apart about the locking ring 40 in substantially the same integrals as first and second clip members 42 and 46, respectively. First and second guide members 43 and 44 can be on an opposing end from projecting tabs 48. First guide members 43 can comprise a width along outer wall 41 substantially equal to that of first clip members 42. Second guide members 44 can comprise a width along outer wall 41 substantially equal second clip members 46. First and second guide members 43 and 44, substantially project, or point, radially outwards from the body of locking ring 40 to help guide the insertion of a support member into the duct system during formation of one or more concrete segments. Support members can support the weight of the wet concrete poured about the duct system during formation of the concrete segments.

Locking member LM can comprise an alternative embodiment of locking ring 60, as illustrated by FIGS. 4C and 4E. Locking ring 60 can comprise any tough but flexible material known in the art, for example, a nylon super tough material. Locking ring 60 comprises a first body portion 61 which can be angled with respect to a second body portion 62. First 61 and second 62 body portions are substantially cylindrical and hollow bodies. First body portion 61 can comprise one or more locking portions 70 separated by one or more channels 74 cut into the first body portion 61. Locking portions 70 can be spaced radially apart in distance about a circumference of locking ring 60. Locking portions 70 can comprise a locking surface 72 to engage other components during the formation process of one or more concrete segments, for example to grip the duct hub 14 or other components. First body portion 61 can comprise a first inner wall 63 which is angled with respect to a second inner wall 64 of second body portion 62.

Still referring to FIGS. 4C and 4D, second body portion 62 of locking ring 60 can comprise one or more second locking portions 66 separated by one or more second channels 76. Second locking portions 66 can comprise second locking surfaces 68 which can also engage various surfaces of components during formation of concrete segments. Second body portion 62 can receive a support component (not shown) during formation of the concrete segments which can support the ducts 12 from the weight of poured and cast concrete. This process is further described below with respect to FIG. 9. When a support component is received into second body portion 62 of locking ring 60, lock portions 70 of first body portion 61 can flex radially outwards from the locking ring 60, as indicated by directions Z1 and Z2. When locking portions 70 flex outwardly, the first locking surfaces 72 are capable of engaging other components, for example, opposing surface 39 of duct hub 14.

Another embodiment of locking member LM is illustrated in FIGS. 4E and 4F. Locking members LM can be used during formation of one or more concrete segments to link one or more duct hub 14 to forming structures, such as illustrated and described in FIGS. 6 and 7, or locking member LM can link one or more duct hubs together when forming a match-cast concrete segment as shown and described in FIG. 9. Locking member LM can comprise locking ring 150. Locking ring 150 comprises a substantially circular and hollow body. Locking ring 150 comprises an inner wall 152 and an outer wall 154. The walls of locking ring 150 can be divided into one or more portions by one or more passages 162. Passages 162 can be spaced apart along the outer wall 154 at alternating intervals and along opposing edges of locking ring 150. Locking member can comprise a first portion 166 formed between one or more passages 162. First portion 166 comprises a first edge 156. A second portion 168 can form between one or more passages 162 and can form adjacent to first portion 166 as well as opposite first portion 166. First portion 166 and second portion 168 can comprise a repeating pattern about locking ring 150. Second portion 168 can comprise a second edge 158. Second edge 158 can comprise an angled blade having a lip, or stop surface 162. Stop surface 162 can be configured for positioning and abutting another component, such as opposing edge 39 of duct hub to frictionally engage the opposing edge 39.

Locking ring 150 further comprises one or more ribs 160 disposed about outer wall 154. Rib 160 can form along first portion 166 of locking ring 150, adjacent and spaced apart from first edge 156. Rib 160 can form along first portion 166 which alternates about locking member with second portion 168. One or more ribs 160 can form adjacent opposing edges 156 such that they are spaced apart a first distance along the outer wall 154. Other components or portions thereof, such as forming member 18, can be positioned about the locking ring 150 within the first distance between one or more ribs 160. In the cross sectional view of FIG. 4F, a space 161 can form between ribs 160 of one or more first portions 166 and stop surfaces 162 of one or more second portions 168. Space 161 can be configured for fitting about second protrusion 38B of duct hub 14 and for linking a first duct hub 14 to an opposing duct hub 14.

FIGS. 4G and 4H illustrate perspective and cross-sectional views of a further embodiment of locking member LM. Locking member LM can comprise locking ring 170. In this embodiment, locking ring 170 comprises a substantially circular, hollow body having an inner wall 172 and an outer wall 174. Similar to locking ring 150, locking ring 170 can comprise one or more portions formed by one or more notches 176. Notches 176 can be spaced apart along the outer wall 174 at alternating intervals and along opposing edges of locking ring 170. Locking member can comprise a first portion 184 formed between one or more passages 176. First portion 184 comprises an edge 180. Edge 180 comprises an angled blade having a lip, or stop surface 182. A second portion 186 can form between one or more passages 176 and can form adjacent to first portion 184 as well as opposite first portion 184. First portion 186 and second portion 184 can comprise a repeating pattern about locking ring 170. Second portion 168 can comprise edge 180 with stop surface 182. Stop surface 182 can be configured for positioning and abutting another component, such as opposing edge 39 of duct hub to frictionally engage the opposing edge 39.

Locking ring 170 further comprises one or more ribs 178 disposed about outer wall 174. Rib 178 can be located adjacent and spaced apart from edge 180. One or more ribs 178 can form adjacent opposing edges 180 such that they are spaced apart a first distance along the outer wall 174. Other components or portions thereof, such as forming member 18, can be positioned about the locking ring 170 within the first distance between one or more ribs 178. In the cross sectional view of FIG. 4F, a space 190 can form between ribs 178 of one or more first portions 184 and stop surfaces 182 of one or more second portions 168. Space 190 can be configured for fitting about second protrusion 38B of duct hub 14 and for linking a first duct hub 14 to an opposing duct hub 14.

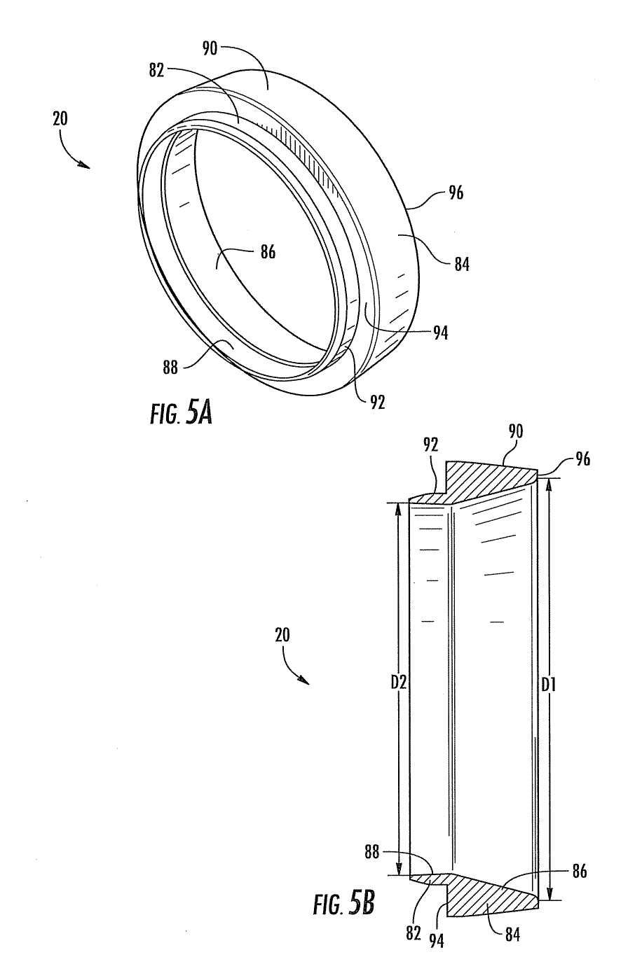

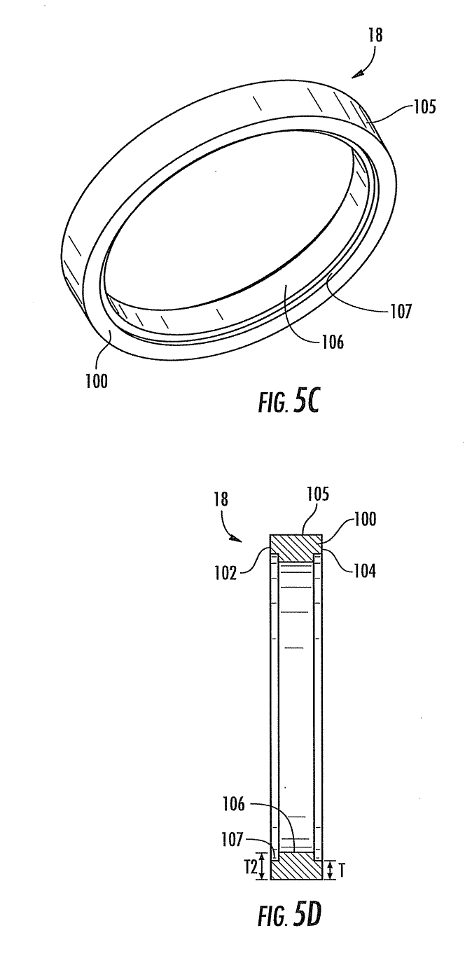

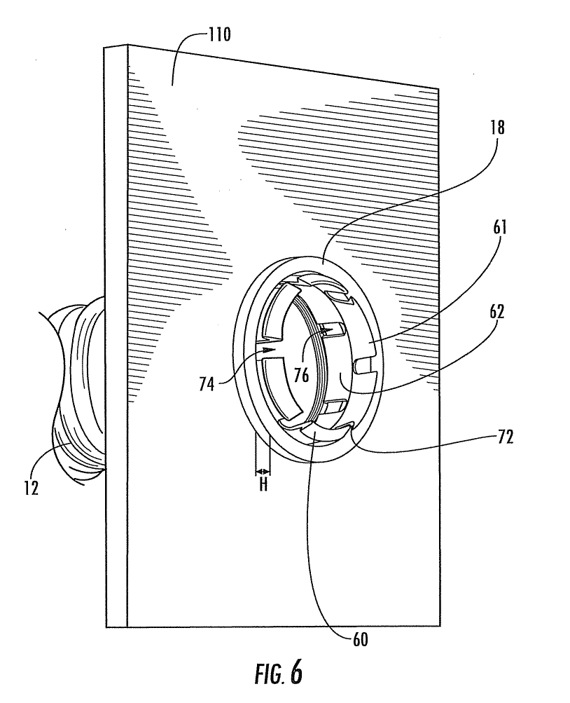

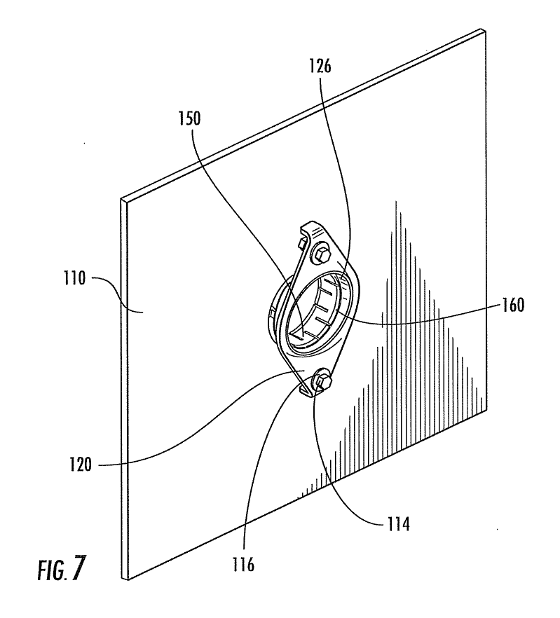

Referring now to FIGS. 5A to 5D, deformable member 20 and forming member 18 are illustrated. Deformable member 20 can comprise a flexible material, for example, TPV or any other elastomeric material known in the art. Deformable member 20 can be designed to be disposed between opposing concrete segments, for example, upon shelf 36 of opposing duct hubs 14 and compressed, thus effectively coupling and sealing the interface between the concrete segments. Deformable member 20 can comprise a substantially cylindrical shape about a hollow interior, and deformable member 20 can comprise a first body portion 84 and a second body portion 82 extending from first body portion. First body portion 84 comprises an opening diameter D1, the opening diameter D1 tapering along a first inner wall 86 to a constant second diameter D2 where D2 can be less than or equal to D1. Second body portion 82 comprises a second opening equal to second diameter D2. First portion 81 of deformable member 20 comprises a flat outer surface 96 opposite and parallel to a second flat outer surface 94. First inner wall 86 can connect the first and second flat outer surfaces 96 and 94, the first inner wall tapering from the first outer surface 96 to the second outer surface 94. The first inner wall tapers inwardly from first diameter D1 to second diameter D2. A first outer wall 90 surrounds first body portion 84 and tapers in a reverse direction than inner wall 86, thus thickening the first body portion from first outer surface 96 to second outer surface 94. Second outer surface 94 can be disposed between first body portion 84 and second body portion 82. Second body portion 82 can comprise an annular ring extending from first body portion 84. In an alternative embodiment, deformable member 20 can comprise a member having only the first body portion 84, thus second body portion 82 would not be present and extending from the first body portion 84. As described later with respect to FIG. 10, first and second outer surfaces 96 and 94, respectively, can be adapted to fit between and engage respective shelves 36 of opposing duct hubs 14 thereby effectively coupling and sealing the concrete segments along an interface.

FIGS. 5C and 5D illustrate forming member 18. Forming member 18 can be used during the forming process which creates one or more concrete segments, and can seal the segments during formation. Forming member 18 can also be used to specifically form the wet concrete by creating a recess in a concrete segment upon drying. Forming ring 18 can form a space, or recess, in which deformable member 20 may be placed before coupling one or more segments at, for example, a work site. This is also described later with respect to FIGS. 9 and 10. Once wet concrete dries about forming member 18, a recess is left in its absence upon subsequent removal of forming member 18. The formed concrete can now have a space for deformable member 20 to fit into once compressed. Similar to deformable member 20, forming member 18 can comprise any flexible material known in the art, for example, TPV or other elastomeric material.

Forming member 18 can comprise a substantially circular body 100 about a hollow opening. Body 100 comprises first and second outer surfaces 102 and 104. Outer surfaces 102 and 104 parallel each other and can engage other components, for example, shelves 36 of opposing duct hubs 14, to effectively couple and seal an interface between opposing concrete segments upon formation. Body 100 comprises a variable thickness, ranging from the thickness T along a first inner wall 107 to a greater thickness T2 along a second inner wall 106. A portion of body 100 having thickness T2 can be disposed between two portions of body 100 having thickness T. First inner wall 107 can comprise a smaller diameter than second inner wall 106 as a result of its greater thickness T2. Forming member 18 can comprise a substantially circular outer wall 105.

In one embodiment, concrete segments can be formed as a matching pair, the concrete being formed about an internal duct 12 segment and various duct components. For example, a first concrete segment can be poured, and allowed to set and dry. A second concrete segment having a face matching the first concrete segment can then be poured, or cast, opposite the first concrete segment. The first and second segments contain internal ductwork which can then be separated until ready to be coupled together to form a structure on a work site. FIGS. 6 and 7 illustrate an assembly used in the formation process of a matching pair of concrete segments. The assembly comprises duct components assembled with forming components. For example, a form bulkhead 110 can be assembled to duct components. Form bulkhead 110 can form the shape of an interface between two opposing concrete segments, and may be at an angle offset from normal.

FIG. 6 illustrates forming member 18 extending through form bulkhead 110. Forming member 18 extends to a height H. Wet concrete forms about height H, such that upon removal of forming member 18 a space of formed concrete is created. First portion 61 of locking ring 60 can fittingly engage and extend through forming member 18. Locking ring 60 serves to temporarily connect duct 12 segments for a matching pair of concrete segments during formation. For example, locking surface 72 can extend through bulkhead 110 and lock to a surface of another component, such as opposing surface 39 of duct hub 14 on a coupling end 22 or 24 of a duct coupling system 10. First portion 61 of locking ring 60 can engage and connect to a first coupling end (22 or 24) of a first concrete segment, and second portion 62 of locking ring 60 can engage and connect to a second, opposing coupling end (22 or 24) of a second concrete segment. Therefore, locking ring 60 can temporarily connect two coupling ends of opposing duct 12 segments during formation of a matching pair of concrete segments.

FIG. 7 illustrates another embodiment of bulkhead 110 assembled to various duct components. In this embodiment, bulkhead 110 can be formed having openings for receiving both attachment components and duct connecting components. Attachment components can comprise, for example, one or more bolts 114 having one or more intermediate portions 116, for example, a washer. Any attachment components known in the art may be used. Duct components comprise locking ring 150 attached to a forming tool 120. For example, stop surface 164 of second edge 158 can engage a portion of forming tool 120 such that first and second guide members 43 and 44, respectively, can form about a first internal surface 126 of forming tool 120. Forming tool 120 can attach to bulkhead 110 using one or more bolts 114. Bulkhead 110 can form an interface between a matching pair of opposing concrete segments.

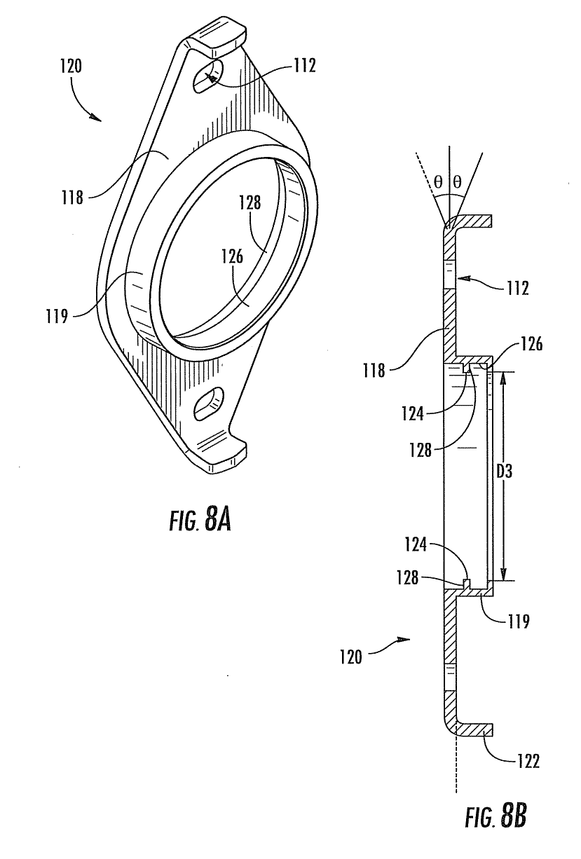

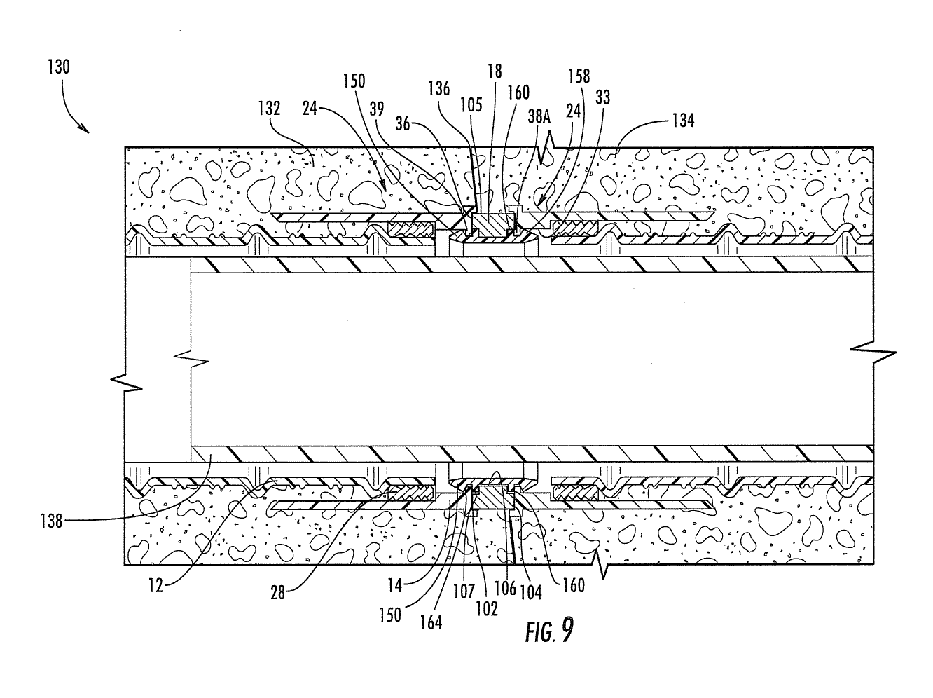

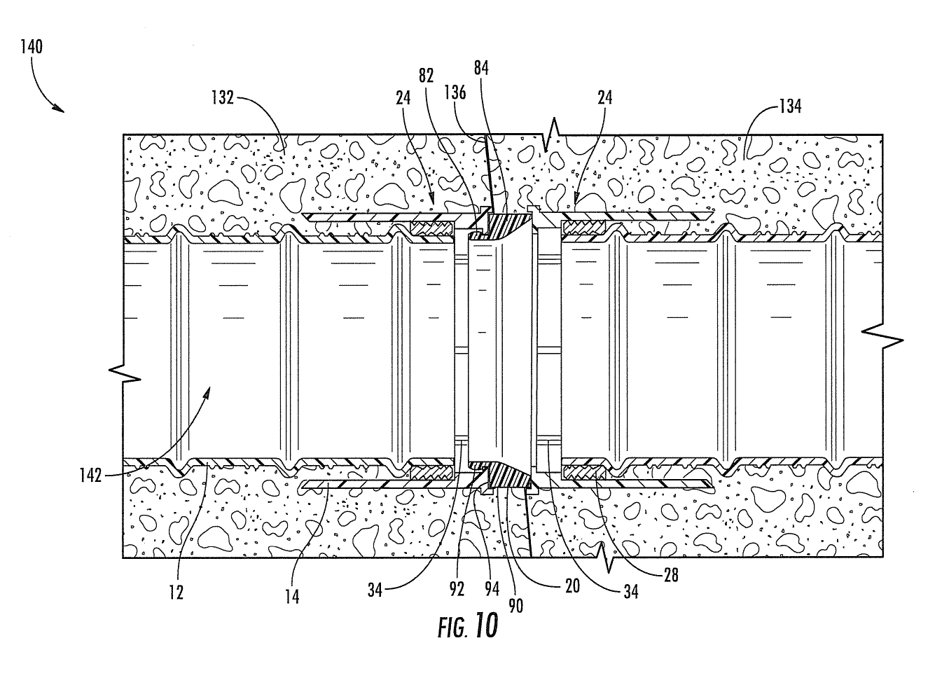

FIG. 8 illustrates perspective and cross-sectional views of forming tool 120. Forming tool 120 can comprise a substantially elongated and diamond shaped body portion 118. Body portion 118 comprises extreme ends 122 which curve about bored, or otherwise formed, holes 112. Extreme ends 122 can curve and extend laterally, approximately 90 degrees (90°), from body portion 118. Bolts 114 having one or more intermediate portions 116 per side can extend through holes 112 and into bulkhead 110. Forming tool 120 is capable of pivoting about bolts 114 by an angle θ when attached to bulkhead 110. Angle θ can comprise any angle offset from normal, that is, θ can comprise any angle equal to or greater than +/−0 degrees (0°) from normal. In one aspect θ can comprise a range of +/−10 degrees (10°) from normal. As a result, a pair of concrete segments can be poured and cast having an interface offset an angle θ from normal.

Still referring to FIGS. 8A and 8B, form tool can comprise a collar portion 119 having an inner wall 126. Collar portion 119 comprises an opening of a diameter D3 which is capable of receiving a support member which can insert into the duct segment during pouring of a first concrete segment. The support member can support duct 12 segment under the weight of the wet concrete during formation of the first concrete segment, and support member can be removed once the first concrete segment of a pair has been cast. Collar portion 119 comprises a rib 124 with an engagement surface 128. Rib 124 and engagement surface 128 can be adapted to engage first and second clip members 42 and 46 of locking ring 40. Rib 124 and engagement surface 128 can also be configured for engaging the space 161 and 190 of locking rings 150 and 170, respectively. Assembling bulkhead 110 to duct components comprises bolting forming tool 120 to bulkhead 110 at a desired angle, and attaching locking ring 40 forming tool 120 by way snapping, clipping, or otherwise affixing, clip members 42 and 46 and/or stop surfaces 164 and 182 of locking members 40, 150, or 170 about rib 124 of forming tool 120.

FIG. 9 illustrates a cross-sectional view of a coupling arrangement, generally designated 130, whereby the coupling arrangement couples together a pre-cast concrete segment 132 and match-cast concrete segment 134 during formation of the match-cast concrete segment 134. Prior to formation of the pair, pre-cast concrete segment 132 is wet cast within a die. Duct 12 with coupling end (24 or 22) can be disposed within pre-cast concrete segment 132. Pre-cast concrete segment 132 can be cast as a single concrete segment (not shown) upon assembling the various duct components to bulkhead 110. For example, the forming tool 120 can be attached to bulkhead 110 using bolts 114. Bulkhead 110 can be pivoted with respect to forming tool 120 at desired angle θ from normal. One of locking rings 40, 60, 150, or 170 can then be positioned, or snapped, upon forming tool 120. For example, first and second clip members 42 and 46 of locking ring 40 can clip or engage rib 124 of forming tool 120. Alternatively, stop surfaces 162 or 182 or locking surfaces 68 or 72 of locking rings 150, 170, and 60, respectively, can frictionally engage rib 124 of forming tool. Once a locking member LM is in place, forming member 18 can then be positioned about locking member LM. If locking ring 60 is used, forming member 18 can be positioned about outer wall between first and second locking surfaces 68 and 72. If locking ring 40 is used, forming member 18 can be placed about projecting portions 55 such that the first inner wall 106 of forming member 18 is disposed in a portion of the space between clip members 42 or 46 and the gripping portion 56 of locking ring 40. If locking rings 150 or 170 are used, forming member 18 can be positioned between one or more parallel ribs 160 or 178.

A duct 12 for casting into the concrete pre-cast segment 132 and having a coupling end, (24 or 22) can then be positioned adjacent forming member 18 such that forming member 18 compresses between shelf 36 of duct hub 14 and rib 124 of forming tool. Forming tool 120 can be positioned at a desired angle θ with respect to the bulkhead 110. A support member, for example, a mandrel 138 can then be inserted into the forming tool 120 opening such that it passes through the desired embodiment of locking member LM. Support member can pass through the coupling end (22 or 24) and then through the duct 12 segment and out of an opposing end of the duct 12 segment which will be located at an opposing end of the pre-cast concrete segment 132. Where locking ring 40 is desired, when mandrel 138 passes through locking ring 40, the width of mandrel 138 causes the one or more projection tabs 48 to flex radially outward, for example, directions Y1 and Y2 (FIG. 4B) and the one or more second surfaces 50 grasp the opposing surface 39 within the duct hub 14 of coupling end 22 or 24. After mandrel 138 is inserted through the length of the duct 12 and coupling end 22 or 24, wet concrete can be poured, allowed to set and dry, thereby forming pre-cast concrete segment 132. Once the concrete has been cast, mandrel 138 can be removed and bulkhead 110 can be removed from a face of the pre-cast concrete segment 132. Forming member 18 can be removed from about locking member LM and can be visually inspected. If there are no significant cuts, tears, or damage, forming member 18 can be retained for reuse in forming the second of the concrete pair. Locking member LM can be removed and inspected, and if there is no significant damage, it can be retained for use in forming the second of the concrete pair.

Forming the pre-cast concrete segment 132 can occur prior to the formation of the pair of concrete segments illustrated by FIG. 9. FIG. 9 illustrates a step in the formation process where a match-cast concrete segment 134 is cast, or formed, adjacent the pre-cast concrete segment 132. An interface 136 forms between dried concrete of the pre-cast concrete segment 132 and wet concrete of the match-cast concrete segment 134. Interface 136 can form at an angle which is consistent with angle θ at which forming tool 120 pivots with respect to bulkhead 120. An angled interface 136 allows ducts to have a longitudinal axis offset from normal within the concrete segments, or offset from interface 136 formed by bulkhead 110. Interface 136 can be substantially perpendicular, or normal to longitudinal duct 12 segments cast within the concrete segments, or can optionally become offset by angle θ if the forming tool 120 is pivoted during formation of the pre-cast concrete segment 132.

As FIG. 9 illustrates, pre-cast concrete segment 132 can be formed adjacent to match-cast concrete segment 134. Interface 136 between the segments can comprise an angle θ which can be offset from normal. To form match-cast concrete segment 134, locking member LM, here locking ring 150 is shown, and forming member 18 retained from forming pre-cast concrete segment 132 described earlier can be reused to link the coupling end 24 of pre-cast concrete segment 132 to coupling end 24 of match-cast concrete segment 134 such that the concrete can then be cast around the duct 12 segment within match-cast concrete segment 134. As noted previously, an alternative embodiment of coupling end 22 could also be used, however, FIG. 9 illustrates coupling end 24. Alternative embodiments of locking member LM can also be chosen for use, for example, one of locking member 40, 60, 150, or 170.

Prior to pouring the concrete for the match-cast concrete segment 134, locking ring 150 can be positioned and disposed between each of the respective hubs 14 of opposing coupling ends 24, that is the ends of the pre-cast concrete segment 132 and the to be formed match-cast concrete segment 132. For example, the one or more stop surfaces 164 can be positioned adjacent the opposing surface 39 within the duct hub 14 of pre-cast concrete segment 132, while the second protrusion 38B of duct hub 14 can fittingly engage in the space 161 formed between end 158 and rib 160 of locking ring 150 of the to be formed match-cast concrete segment 134. Thus, locking ring 150 can be positioned such that it engages between opposing duct hubs 14 of the pre-cast concrete segment 132 and the match-cast concrete segment 134 to link the hubs 14 together. FIG. 9 illustrates the concrete having been formed, but illustrates the correct positioning of the locking ring, coupling ends 24, and forming member prior to pouring the concrete for match-cast concrete segment 134. Forming member 18 can be positioned, and disposed between opposing coupling ends 24. Forming member 18 can be disposed between the shelf portions 36 of coupling ends 24. Forming member 18 can engage the surface formed between one or more opposing ribs 160 of locking ring 150. The majority of the forming member can be contained within the match-cast concrete segment 134 to form the concrete of the match-cast concrete segment 134 in a certain manner. For example, once wet concrete is poured, it assembles about outer wall 105 of forming member 18 such that at least a portion of forming member 18 engages a portion of the match-cast concrete segment 134. Upon removal of forming member 18 a formed space, or recess can remain in the space which was previously occupied by the forming member 18. The formed concrete allows positioning of deformable member 20 prior to coupling of the two cast segments on a work site. FIG. 9 illustrates duct 12 with coupling end 24 disposed within match-cast concrete 134 segment.

Still referring to FIG. 9, once the locking ring 150 and forming member 18 are positioned between the opposing coupling ends 24 of the pre-cast concrete segment 132 and before the match-cast concrete segment 134 is poured, a support member can be inserted into the duct. A support member can comprise, for example, a mandrel 138 which can support the ducts 12 under the weight of the wet concrete. Mandrel 138 can slide into ducts 12 and through the inner wall 152 of locking ring 150. For illustration purposes, only one coupling end 24 per concrete segment is shown. Duct 12 can terminate at a second coupling end on a segment face opposing and parallel to interface 136. Mandrel 138 therefore can be inserted through a segment face and coupling end of one concrete segment, extend through the opposing coupling ends 24 and interface 136, and then pass out of the segment face and coupling end opposing the interface 136. If locking ring 40 is used, then when the mandrel 138 is inserted, one or more projection tabs 48 can flex radially outward causing the second surface 50 of gripping portion 56 to be held against, and frictionally engage opposing surface 39 of duct hub 14. That is, the slightly curved projecting portion 55 becomes substantially flat, held vertically flat against the outer surface of mandrel 138. Once the mandrel 138 has been positioned through the length of the coupled duct 12 segments, the concrete can be poured, thus forming the match-cast concrete segment 134 as shown.

Once the match-cast concrete segment 134 is cast, mandrel 138 can be removed. Match-cast concrete segment 134 and pre-cast concrete segment 132 can be subsequently physically separated along interface 136. Locking ring 150 and forming member 18 can be removed and retained for reuse if not significantly damaged. Internal ducts 12 and coupling ends 24 are now effectively cast within the respective concrete segments and await assembling on a work site. If desired, one or more protective caps (not shown) can be inserted over coupling ends 24 to protect the ends until they are coupled at a work site.

FIG. 10 illustrates a cross-sectional view of a coupling arrangement, generally designated 140, whereby the coupling arrangement couples together a pre-cast concrete segment 132 and match-cast concrete segment 134 after formation of the segments where, for example, the segments are coupled on a work site, prior to insertion of post-tensioning elements. FIG. 10 illustrates the pair of concrete segments comprising pre-cast concrete segment 132 adjacent match-cast concrete segment 134 with interface 136 disposed therebetween. After formation of the pair of segments, the pair can be physically separated. Upon separation, locking ring 150 and forming member 18 can be removed. As a majority portion of forming member 18 was located in the match-cast concrete segments 134, upon removal of forming member 18 formed concrete is left in its place. The formed concrete is sized adapted to receive deformable member 20. Deformable member can be positioned between respective coupling ends 24 of concrete segments, such that at least a portion of the deformable member is adjacent the match-cast concrete segment 134 in a space previously occupied by forming member 18. As FIG. 10 illustrates, deformable member 20 can be positioned on one concrete segment face, having second flat outer surface 94 matingly engaged with shelf 36 of pre-cast concrete segment 132, and second body portion 82 extending into the coupling end 24 of the pre-cast concrete segment 132. The faces of the opposing segments, the faces forming interface 136, can be coated with glue, epoxy, or other sealing material to facilitate bonding of the concrete segments. Once the concrete segments have been compressed together and joined, the tapered outer wall 90 of first body portion 84 of deformable member 20 can be adapted to fit into the recess left when forming member 18 is removed, and can engage with at least a portion of the shelf 36 of coupling end 24 of the opposing match-cast concrete segment 134. Thus, deformable member 20 can be disposed between the opposing coupling ends 24 of the pre-cast 132 and match-cast 134 concrete segments when the segments are joined. Deformable member 20 can have outer surface 90 positioned adjacent formed concrete of the match-cast concrete segment 134 such that at least a portion of the deformable member 20 engages a portion of the match-cast concrete segment 134. When opposing coupling ends 24 of pre-cast concrete segment 132 and match-cast concrete segment 134 are joined, duct coupling system 10 is formed wherein the duct 12 segment of pre-cast concrete segment 132 and duct 12 of the match-cast concrete segment 134 form a passage 142 in which post-tensioning elements can be inserted. The pair of concrete segments becomes compressed when post-tensioning elements (not shown) such as metal rods or bars are inserted and tensioned. The post-tensioning elements can pass through the coupled duct system 10 within the pair of concrete segments and can compress the faces of the concrete segments together, thus compressing deformable member 20. Deformable member 20 can compress to form an effective seal, to keep out moisture and/or other corrosive agents. As illustrated and described here, deformable member 20 can be disposed between opposing coupling ends 24 of opposing concrete segments joined at interface 136, and the coupling ends 24 can substantially align along the interface 136 such that the passage 142 can be substantially unobstructed. This can allow easier positioning of the post-tensioning elements within the continuous passage 142.

FIG. 11 illustrates a cross-sectional view of a duct system 10 within a framework 144 prior to pouring the concrete segments. An advantage of using the methods, systems, and apparatuses described herein is illustrated, which is that duct system 10 can be offset from normal with respect to each sealing face of the respective pre-cast and match-cast concrete segments 132 and 134, respectively, and still be able to effectively couple. FIG. 11 illustrates framework 144 in which one or more concrete segments may be formed. For example, pre-cast concrete segment 132 is adjacent to match-cast segment 134 having an interface formed therebetween by bulkhead 110. By using a flexible, deformable member 20 in between coupling ends 24, it is possible to effectively couple and seal the duct system 10 at an angle offset from normal. Deformable member 20 can deform when compressed and fill the recess of the formed concrete left by forming member 18 during the formation process.

Embodiments of the present disclosure shown in the drawings and described above are exemplary of numerous embodiments that can be made within the scope of the appended claims. It is contemplated that the configurations of segmental duct couplers such as those disclosed herein can comprise numerous configurations other than those specifically disclosed.

What is claimed is:

1. A duct coupling system for use in assembling concrete segments, the system comprising:
a first duct segment disposed within a first concrete segment, the first duct segment comprising a first coupling end; and
a deformable member;
wherein the first coupling end is disposed within a first concrete segment, and a first portion of the deformable member engages a portion of the concrete segment and a second portion of the deformable member engages the first coupling end.

2. The duct coupling system of claim 1, wherein the first coupling end comprises a first duct hub and a first duct ring, wherein the first duct ring is disposed between the first duct hub and the first duct segment.

3. The duct coupling system of claim 1, wherein the first coupling end comprises a first duct hub and a first external member, wherein the external member is disposed about each of the first duct hub and first duct segment such that a gap exists between the first duct hub and first duct segment.

4. The duct coupling system of claim 2, wherein the deformable member is disposed between a first coupling end and a second coupling end, the first and second coupling ends aligning along opposing faces of the first concrete segment and a second concrete segment.

5. The duct coupling system of claim 4, wherein an interface is disposed between the first concrete segment and the second concrete segment.

6. The duct coupling system of claim 5, wherein the interface is angled at an angle offset from normal.

7. The duct coupling system of claim 6, wherein the angle comprises a range from +/−10 degrees from normal.

8. The duct coupling system of claim 1, wherein the deformable member comprises a first body portion and a second body portion, the first body portion comprising a first diameter that varies along a first inner wall, and the second body portion comprising a second diameter.

9. A duct coupling system for use in assembling concrete segments, the system comprising:
a first coupling end comprising:
a first duct segment;
a first duct hub;
a first duct ring, the first duct ring being disposed between the first duct segment and the first duct hub; and
a deformable member;
wherein the first coupling end is configured for positioning within a first concrete segment with a segment face offset a given angle from normal and angled with respect to a longitudinal axis of the first duct segment.

10. The duct coupling system of claim 9, wherein the segment face is offset from normal by +/−10 degrees.

11. The duct coupling system of claim 9, wherein the deformable member is disposed between the first coupling end of the first concrete segment and a second coupling member of a second concrete segment.

12. The duct coupling system of claim 11, wherein the second duct coupling end comprises:
a second duct segment;
a second duct hub; and
a second duct ring, the second duct ring being disposed between the second duct segment and the second duct hub.

13. The duct coupling system of claim 12, wherein the deformable body comprises a first body portion and a second body portion, the first body portion engaging the first duct hub of the first coupling end and the second body portion engaging the second duct hub of the second coupling end.

14. The duct coupling system of claim 9, wherein the deformable member comprises a thermoplastic elastomer.

15. The duct coupling system of claim 12, wherein the first duct segment of the first coupling end and the second duct segment of the second coupling end form a passage whereby post-tensioning elements can be inserted.

16. A coupling end used to assemble a first and a second concrete segment, the coupling end comprising:
a duct segment;
a duct hub; and
a first external member;
wherein the external member is disposed about each of the first duct hub and first duct segment such that a gap exists between the first duct hub and first duct segment.

17. The coupling end of claim 16, wherein the duct hub comprises a shelf for receiving a deformable member.

18. The coupling end of claim 16, wherein the coupling end is adapted for being cast within a first concrete segment such that a shelf of the duct hub lies along a face of the first concrete segment.

19. The coupling end of claim 18, the coupling end is configured to couple the first concrete segment to a second concrete segment.

20. The coupling end of claim 19, wherein the coupling end is configured to couple to a second coupling end by positioning a deformable member therebetween.

21. The coupling end of claim 20, wherein the deformable member comprises a thermoplastic elastomer.

22. A method of coupling concrete segments during formation of the concrete segments; the method comprising:
forming a first concrete segment about a first duct segment having a first coupling end, the first coupling end comprising:
a first duct hub; and
a first duct ring, the first duct ring disposed between the first duct hub and the first duct segment;
positioning a portion of a locking ring onto the first duct hub;
positioning a forming member about the locking ring; and
coupling the first duct segment to a second duct segment, the second duct segment having a second coupling end and wherein the locking ring and forming member are disposed between the first and second coupling ends.

23. The method of claim 22, wherein the second coupling end comprises:
a second duct hub; and
a second duct ring, the second duct ring disposed between the second duct hub and the second duct segment.

24. The method of claim 23 further comprising:
positioning a support member through the first and second duct segments; and
forming a second concrete segment about the second duct segment and second coupling end, the second concrete segment being adjacent the first concrete segment.

25. The method of claim 24, wherein the support member causes at least one projection tab on the locking member to flex outwardly and engage the duct hub of the second coupling end.

26. The method of claim 24, wherein forming the second concrete segment comprises pouring wet concrete about the second duct segment and second coupling end, whereby the concrete forms around the forming member.

27. The method of claim 26 further comprising the step of:
removing the support member;
physically separating the first concrete segment from the second concrete segment;
removing the forming member and locking ring; and
positioning a deformable member into a space formed and previously occupied by the forming member.

28. The method of claim 22, wherein positioning the locking ring onto the first duct hub comprises clipping one or more clip members onto a surface of the duct hub.

29. A method of coupling cast concrete segments, the method comprising:
forming a first concrete segment about a first duct segment and coupling end;
forming a second concrete segment about a second duct segment and coupling end; and
positioning a deformable member between the coupling ends, such that at least a portion of the deformable member engages a portion of the first or second concrete segment.

30. A method of claim 29, wherein positioning the deformable member comprises positioning a first surface of the deformable member against a first shelf of the first coupling end, and positioning a second surface of the deformable member against a second shelf of the second coupling end.

31. The method of claim 29 further comprising the step of compressing the deformable member such that it forms an effective seal along an interface of the first and second concrete segments.
